(19) United States
(12) Patent Application Publication
(10) Pub. No.: US 2026/0277767 A1
(43) Pub. Date: Sep. 17, 2026

(54) LIFE CYCLE MANAGEMENT METHOD AND APPARATUS, AND STORAGE MEDIUM

(71) Applicant: Beijing Xiaomi Mobile Software Co., Ltd., Beijing (CN)

(72) Inventors: Min LIU, Beijing (CN); Zhengxuan LIU, Beijing (CN); Qin MU, Beijing (CN)

(73) Assignee: Beijing Xiaomi Mobile Software Co., Ltd., Beijing (CN)

(21) Appl. No.: 19/471,308

(22) PCT Filed: Apr. 7, 2023
(86) PCT No.: PCT/CN2023/087151

§ 371 Date: Sep. 30, 2025

(51) Int. Cl. G06F 11/34

(52) U.S. Cl. CPC G06F 11/3447

(57) ABSTRACT

A method for life cycle management (LCM), includes: sending first information to a network (NW) device, where the first information indicates artificial intelligence (AI) information supported by a user equipment; receiving second information sent by the NW device, where the second information indicates LCM indication information; and determining a life cycle of an AI model corresponding to the AI information according to the second information.

### CROSS-REFERENCE TO RELATED APPLICATIONS

The present application is a U.S. National Stage of International Application No. PCT/CN2023/087151, filed on Apr. 7, 2023, the contents of all of which are incorporated herein by reference in their entirety for all purposes.

### BACKGROUND OF THE INVENTION

In an artificial intelligence (AI) architecture in the field of communications, for an AI model based on a dual-sided structure, an encoder part is deployed on a user equipment (UE) side, while a decoder part is deployed on a network (NW) side. The UE encodes measurement information via an AI encoder model and then sends it to the NW side. The NW side decodes the sent information based on an AI decoder model to obtain the measurement information.

### SUMMARY OF THE INVENTION

The present disclosure relates to the technical field of communications, particularly a method and device for life cycle management, and a storage medium.

According to a first aspect of embodiments of the present disclosure, a method for life cycle management (LCM) is provided, which is performed by a user equipment. The method includes: sending first information to a network device, where the first information indicates artificial intelligence (AI) information supported by the user equipment; receiving second information sent by the network device, where the second information indicates LCM indication information; and determining a life cycle of an AI model corresponding to the AI information according to the second information.

According to a second aspect of the embodiments of the present disclosure, a method for life cycle management (LCM) is provided, which is performed by a network device. The method includes: receiving first information sent by a user equipment, where the first information indicates artificial intelligence (AI) information supported by the user equipment; generating second information according to the first information, where the second information indicates LCM indication information; and sending the second information to the user equipment, where the second information is configured to indicate that the user equipment determines a life cycle of an AI model corresponding to the AI information according to the second information.

According to a third aspect of the embodiments of the present disclosure, a device for life cycle management is provided, which is applied to a user equipment. The device includes: one or more processors; and a memory that stores processor-executable instructions, where the processor-executable instructions, when collectively executed by the one or more processors, cause the one or more processors to: send first information to a network device, where the first information indicates artificial intelligence (AI) information supported by the user equipment; receive second information sent by the network device, where the second information indicates LCM indication information; and determine a life cycle of an AI model corresponding to the AI information according to the second information.

According to a fourth aspect of the embodiments of the present disclosure, a non-transitory computer-readable storage medium storing computer program instructions is provided, where the computer program instructions, when executed by a processor, cause the processor to perform the method described in the first aspect of the present disclosure.

It is to be understood that the general description above and the detail description below are merely exemplary and explanatory, and are not intended to limit the present disclosure.

### BRIEF DESCRIPTION OF DRAWINGS

The accompanying drawings, which are incorporated in and constitute a part of the specification, illustrate embodiments consistent with the present disclosure, and, together with the description, serve to explain the principles of the present disclosure.

FIG. 1 is a schematic diagram of a relationship among an AI feature, an AI functionality, and an AI model according to an example.

FIG. 2 is an example diagram of a CSI compression dual-model according to an example.

FIG. 3 is a flowchart of a method for life cycle management according to an example.

FIG. 4 is a flowchart of a method for life cycle management according to an example.

FIG. 5 is a flowchart of a method for life cycle management according to an example.

FIG. 6 is a flowchart of a method for life cycle management according to an example.

FIG. 7 is a flowchart of a method for life cycle management according to an example.

FIG. 8 is a flowchart of a method for life cycle management according to an example.

FIG. 9 is a flowchart of a method for life cycle management according to an example.

FIG. 10 is a flowchart of a method for life cycle management according to an example.

FIG. 11 is a flowchart of a method for life cycle management according to an example.

FIG. 12 is a block diagram of a device for life cycle management according to an example.

FIG. 13 is a block diagram of a device for life cycle management according to an example.

FIG. 14 is a block diagram of a user equipment according to an example.

FIG. 15 is a block diagram of a network device according to an example.

### DETAILED DESCRIPTION OF THE INVENTION

Examples will be described in detail here, and these examples are shown in the accompanying drawings. When the following description involves the accompanying drawings, the same numerals in different accompanying drawings refer to the same or similar elements, unless otherwise indicated. Implementations described in the examples below do not represent all implementations consistent with the present disclosure. Instead, these implementations are merely examples of devices and methods that are consistent with some aspects of the present disclosure and that are detailed in the appended claims.

It is to be understood that “a plurality of” in the present disclosure refers to two or more, and other quantifiers are interpreted similarly. “And/or” describes an association relationship between associated objects, indicating three existing relationships. For example, A and/or B may represent the following three cases: A exists alone, both A and B exist, or B exists alone. Character “/” generally represents an “or” relationship between two successive associated objects. Singular forms of “a/an,” “the,” and “this” are also intended to include plural forms, unless the context clearly indicates otherwise.

It is to be further understood that terms such as “first” and “second” are configured to describe various pieces of information, but they are not expected to be limited to these terms. These terms are merely configured to distinguish information of the same type from one another and do not imply a specific order or degree of importance. In fact, the expressions such as “first” and “second” may be interchangeable. For example, first AI model ID information may also be referred to as second AI model ID information. Similarly, the second AI model ID information may also be referred to as the first AI model ID information, without departing from the scope of the present disclosure.

It is to be further understood that although operations or steps are described in a specific order in the embodiments of the present disclosure or the accompanying drawings, this is not construed as requiring these operations or steps to be performed in the specific order shown or a serial order shown, or requiring all the shown operations or steps to be performed to achieve a desired result. In the embodiments of the present disclosure, these operations or steps may be performed in any order, in parallel, or partially, or the operations or steps in a plurality of embodiments or accompanying drawings may also be combined arbitrarily, if there is no contradiction. This is not limited to the present disclosure. In a specific environment, multitasking and parallel processing may be beneficial.

It is to be noted that all actions of obtaining a signal, information, or data in the present application are performed under the premise of complying with the relevant data protection regulations and policies of the respective country and with the authorization granted by the respective device owner.

First, the implementation environment of the embodiments of the present disclosure is introduced below.

The technical solution of the embodiments of the present disclosure may be applied to various communication systems. The communication system may include one or more of the 4th generation (4G) communication system, the 5th generation (5G) communication system, and other future wireless communication systems (such as 6G). The communication system may also include one or more of a public land mobile network (PLMN), a device-to-device (D2D) communication system, a machine-to-machine (M2M) communication system, an Internet of Things (IoT) communication system, a vehicle-to-everything (V2X) communication system, or other communication systems.

In the field of communication networks, an AI model has been applied to different aspects, such as traffic monitoring, intelligent operation and maintenance, security protection, and service analysis. With the advent of new generation network communication technology, such as 5G, the conditions for applying AI technology in the communication network are gradually maturing. On one hand, brand-new network architecture systems defined via software, such as software-defined network (SDN) and network function virtualization (NFV), achieve the decoupling of software and hardware, shield differences in underlying hardware, and provide a foundation for the deployment of artificial intelligence. On the other hand, the complex environments and changing requirements faced by 5G networks drive the evolution of networks from the previous manual mode to an AI-driven intelligent mode.

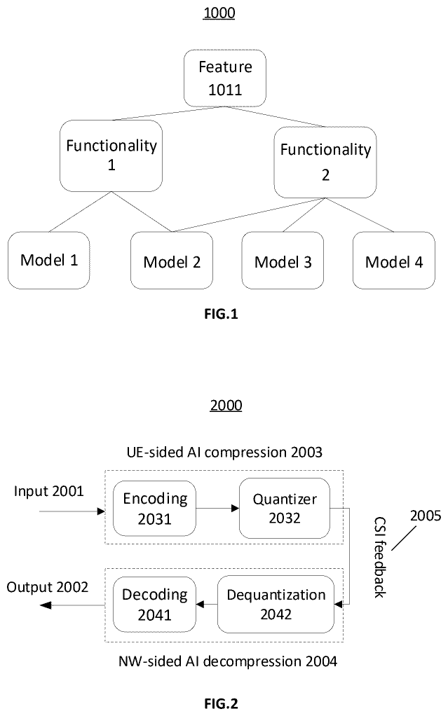

In a related technology, research on the AI architecture in the field of communication networks mainly focuses on the division of features, functionalities, and models. FIG. 1 is a schematic diagram of a relationship among an AI feature, an AI functionality, and an AI model according to an example. As shown in FIG. 1, one feature 1011 in the AI architecture 1000 may be equivalent to one sub-use case. A plurality of sub-use cases may exist in an AI-based physical layer enhancement application scenario. For example, in the AI-based channel state information (CSI) feedback enhancement process, there are two sub-use cases: AI/machine learning (ML)-based CSI compression and AI/ML-based CSI time-domain prediction. Other sub-use cases may be included in other AI architecture application scenarios, which are not limited to the present embodiment. In this AI architecture, one feature 1011 may include a plurality of functionalities, and the same functionality may include one or more AI models. Similarly, one AI model may also be upwardly compatible with one or more functionalities. In an example, there are the functionality 1 and the functionality 2 under the feature 1011. There are the model 1 and the model 2 under the functionality 1, and there are the model 2, the model 3, and the model 4 under the functionality 2.

In the process of applying the AI model, based on differences in functions and application scenarios, the functionalities equipped on different types of UEs vary, and the corresponding AI models configured also differ. To enhance the AI functionalities of the UE, a larger number of AI models may be configured on the UE to meet the application functional requirements under different application scenarios. The application of each AI model may occupy the CPU/GPU of the UE. To avoid overloading the UE by simultaneously enabling a plurality of AI models, the application of the AI models depends on the application scenarios of the UE. In a case where the current application scenario does not need the AI model under a functionality, the AI model under the functionality can be deactivated based on signaling information sent by the NW to improve the performance of the UE. The NW can manage life cycles of various AI models in the UE and the NW via life cycle management (LCM). For example, the NW can achieve functionality-based LCM or model-ID based LCM, based on an application requirement of the current communication scenario. The NW can manage life cycles of various functionalities in the UE by sending the functionality-based LCM to the UE, such as designating activation/deactivation/fallback/switching of the corresponding functionality, based on the functionality-based LCM. The NW can manage a life cycle of an AI model corresponding to a model ID in the UE by sending model-ID based LCM to the UE, such as designating activation/deactivation/selection/switching/update of the corresponding AI models based on the model-ID based LCM.

In a related technology, for different AI application scenarios, based on the above AI architecture, the dual-sided model can be deployed on the NW side and the UE side, including an AI encoder model deployed on the UE side and an AI decoder model deployed on the NW side. For example, FIG. 2 is an example diagram of a CSI compression dual-model according to an example. As shown in FIG. 2, the CSI compression dual-model 2000 includes an input 2001 and an output 2002. The UE-sided AI compression 2003 involves the processing of encoding 2031 and the processing of a quantizer 2032. The NW-sided AI decompression 2004 involves the processing of decoding 2041 and the processing of dequantization 2042. In addition, FIG. 2 also illustrates the CSI Feedback 2005.

As shown in FIG. 2, in the embodiment, taking the scenario of compressing and sending for CSI information as an example, AI-based CSI compression and sending is the dual-sided model. The UE compresses and encodes the measured channel state information via the AI encoder model and sends it to the NW. The NW obtains channel state information by decompressing the compressed and encoded information via the AI decoder model paired with the AI encoder model. In another embodiment, the CSI sending of the UE further includes AI-based CSI prediction sending. The AI model for this CSI prediction sending is a single-sided model deployed on the UE side. The UE predicts CSI information at a future moment based on an AI algorithm and measured historic channel information, and sends the CSI information to the NW. The aforementioned CSI information may be channel matrix information and channel feature vector/matrix information. The CSI information may further be traditional CSI sending quantities such as a channel quality indicator (CQI), a rank indication (RK), and a precoding matrix indicator (PMI). In one embodiment, the CSI sending of the UE is CQI, RI, and PMI sending after AI-based CSI prediction. The AI model for the CSI prediction sending is a single-sided model deployed on the UE side. The UE predicts the channel matrix information at the future moment based on the AI algorithm and the measured historic channel information and sends the CQI, RI, and PMI obtained by processing the channel matrix information to the NW.

For AI model-based information sending, the NW needs to deploy the corresponding AI model via signaling information. For example, taking the above CSI information feedback of the UE as an example, for each type of AI model-based CSI sending, such as AI model-based CSI compression and sending, since the AI model for CSI compression is a dual-sided structure, i.e., the encoder part is deployed on the UE side, and the decoder part is deployed on the NW side, the encoder model and the decoder model appear in pairs. The communication performance may decline due to a mismatch between the encoder and the decoder, in a case where the AI model on one side changes and the other side is unaware of the change.

The applicant has found that in the related technology, the NW may determine the relevant performance of the UE based on the capability sending or functionality sending of the UE. In contrast, the NW side cannot determine which model the UE is using. Hence, for the CSI compression based on the dual-sided model, how to configure a model via the model-ID-based LCM and how to configure a model via the functionality-based LCM to ensure the communication performance of the dual-sided model without the NW knowing the model ID of the UE. Furthermore, for a single-sided model, whether the UE side deploys the LCM of the single-sided model via the functionality-based LCM or the model-ID-based LCM to ensure the communication performance while reflecting differences among different manufacturers. For the above problems, a method for life cycle management is needed to deploy at least one of the following: functionality on the UE side or model LCM on the UE side, such that the communication performance can be ensured.

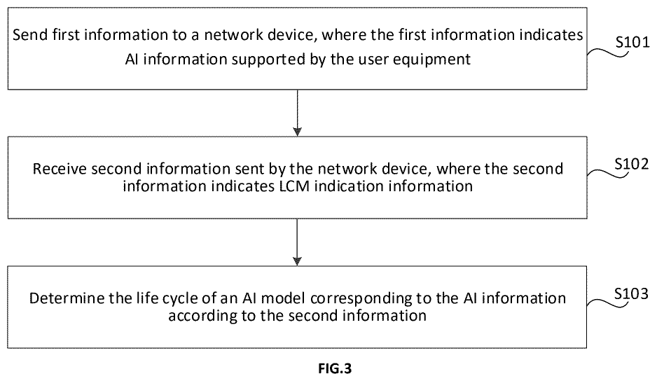

To address the above problems, the embodiments provide a method for life cycle management. FIG. 3 is a flowchart of the method for the life cycle management according to an example. As shown in FIG. 3, the method may be performed by the UE and includes the following steps: S101-S103.

In step S101, first information is sent to a network device, where the first information indicates AI information supported by the user equipment.

The network device provided in any embodiment of the present disclosure may be a device configured to communicate with the user equipment. The network device may also be referred to as an access network device or a wireless access network device, may be a transmission reception point (TRP), an evolved NodeB (eNB or eNodeB) in a long-term evolution (LTE) system, a home base station (such as a home evolved NodeB, or a homeNodeB (HNB)), a baseband unit (BBU), or a wireless controller in a cloud radio access network (CRAN) scenario. Alternatively, the network device may be a relay station, an access point, a vehicle-mounted device, a wearable device, a network device in a 5G network, a network device in a future evolved PLMN network, an access point (AP) in a wireless local area network (WLAN), or a gNB in new radio (NR). The embodiments of the present disclosure are not limited to these examples. The network device will be referred to as a base station below for ease of reading. The user equipment provided in any embodiment of the present disclosure may be a mobile phone, a tablet, a portable computer, a computer with a wireless transceiving function, a virtual reality (VR) terminal, an augmented reality (AR) terminal, a wireless terminal in industrial control, a wireless terminal in smart grid, a wireless terminal in transportation safety, a wireless terminal in smart city, or a wireless terminal in smart home. The application scenarios are not limited to the present disclosure. The user equipment may also be referred to as a user device, a terminal, an access terminal, a UE unit, a UE station, a mobile device, a mobile station, or a mobile client. The user equipment will be referred to as a UE below for ease of reading.

For example, in the embodiment, the UE communicates and interacts with the network device on the NW side based on the above AI architecture. The UE needs to send the first information to the NW side based on its configuration before the UE completes the corresponding communication and interaction function based on an AI model. The first information is the AI information supported by the UE. The AI information may be AI model ID information corresponding to the AI model supported by the UE, or may also be AI function information of the AI model corresponding to the AI information. The network device on the NW side may determine, based on the AI information, a sending function supported by the corresponding UE, and then perform corresponding life cycle management on the AI model of the UE according to the current application scenario requirement and the AI information.

The UE may trigger AI information sending upon connecting to the network device initially. The AI information sending is different from the capability sending and functionality sending of the UE. The AI information is the AI functionality or the AI model information that the UE sends to the NW, based on its supported AI model. The NW determines the AI functionality supported by the UE based on the AI information, and then performs the life cycle management on the corresponding AI model or AI functionality for the UE based on the current application scenario requirement and the AI functionality.

In step S102, second information sent by the network device is received, where the second information indicates LCM indication information.

For example, the network device on the NW side determines the AI functionality or a supported AI model of the UE according to the AI information sent by the UE. Then it deploys the AI model or the AI functionality in the UE accordingly, based on the current application scenario of the NW, to generate the second information. The second information includes the LCM indication information. After generating the LCM indication information, the NW side sends it to the UE. The LCM indication information is configured to indicate the life cycle of at least one AI functionality or at least one AI model in the UE. The LCM indication information may be at least one of: the functionality-based LCM indication information or the model-based LCM indication information. The LCM indication information sent by the NW side may be carried by at least one of: radio resource control (RRC) signaling, medium access control element (MAC CE) signaling, or downlink control information (DCI) signaling.

For example, the network device on the NW side may first determine whether the UE has the AI functionality for CSI prediction or the AI model corresponding to the CSI prediction based on the AI information sent by the UE, in a case where the UE needs to send the current CSI prediction information of the UE within a set time range under the current application scenario of the NW. LCM indication information corresponding to the CSI prediction capability is sent to the UE, in a case where it is determined based on the AI information that the UE can achieve the CSI prediction based on the AI. The LCM indication information may be life cycle management signaling based on the CSI prediction, and the life cycle management signaling may indicate a cycle of activating a CSI prediction capability or a CSI prediction model for the UE.

In one implementation, the LCM indication information includes at least one of: an activation indication, a deactivation indication, a fallback indication, a switching indication, a selection indication, or an update indication for the AI model.

For example, in the embodiment, the LCM indication information is an execution instruction for the AI model generated by the network device on the NW side based on the current application scenario and the AI information. The execution instruction may include at least one of the following: the activation indication (configured to indicate the activation of the corresponding AI model), the deactivation indication (configured to indicate the deactivation of the corresponding AI model), the fallback indication (configured to indicate the fallback of the corresponding AI model to the previous state or an initial state, or indicate switching to a preset AI model or non-AI mode), the switching indication (configured to indicate switching to other AI models), the selection indication (configured to indicate a selection condition for the AI model), or the update indication (configured to indicate updating the corresponding AI model).

In another implementation, the LCM indication information may also be at least one of: an activation indication, a deactivation indication, a fallback indication, a switching indication, a selection indication, or an update indication for an AI function. The UE may determine a target AI model under the AI functionality, based on the LCM indication information of the AI functionality, and then perform the corresponding indication operation based on the target AI model.

In step S103, the life cycle of the AI model corresponding to the AI information is determined according to the second information.

For example, the UE determines the AI functionality or the AI model indicated by the LCM indication information, by parsing the LCM indication information indicated by the second information, and then performs the corresponding life cycle based on the AI functionality or the AI model. It is worth mentioning that in the embodiment, the UE directly performs the life cycle management on the corresponding AI model based on the LCM indication information, in a case where the LCM indication information is model-based LCM indication information. The UE determines one or more AI models supporting the functionality based on its own configuration and then selects one target AI model from the one or more AI models to perform the life cycle management, in a case where the LCM indication information is functionality-based LCM indication information. For example, the UE may select one AI model from a plurality of AI models as the target AI model according to a characteristic of the model, such as complexity, in a case where the plurality of AI models supporting the functionality exist in the UE. For example, the UE may switch from the currently activated AI model to the AI model corresponding to the functionality, in a case where the NW indicates the activation of the functionality via the LCM indication information. The model switching behavior on the UE side may be controlled by the UE based on the current application scenario. In contrast, the NW side simply needs the UE to achieve the corresponding functionality and does not monitor the model switching process of the UE.

By using the above method, the UE sends the supported AI information to the NW, enabling the NW to manage the life cycle of the AI model based on the AI information supported by the UE. This avoids the disruption of the AI function caused by the mismatched AI model and ensures the AI performance during the communication process.

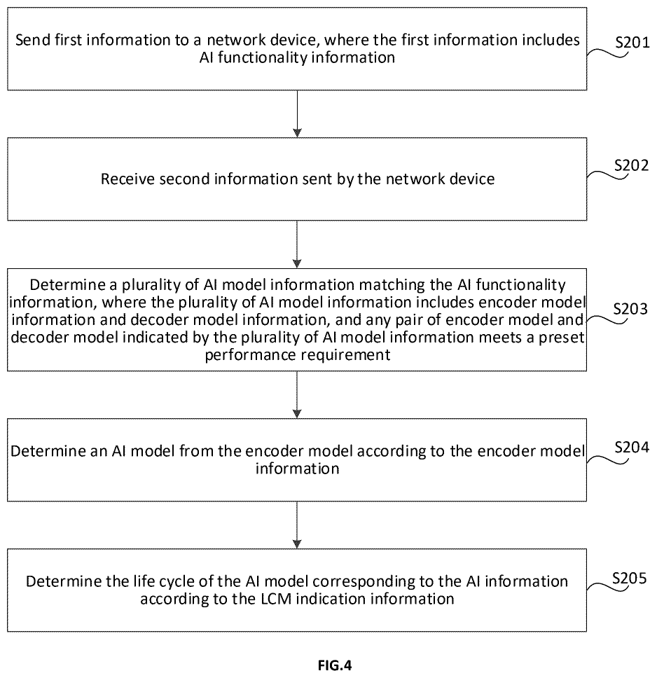

FIG. 4 is a flowchart of a method for life cycle management according to an example. As shown in FIG. 4, the method is performed by the UE and includes the following steps: S201-S205.

In step S201, first information is sent to a network device, where the first information includes AI functionality information.

For example, the AI information in the embodiment includes the AI functionality information. The UE sends the supported AI functionality information to the network device on the NW side. The AI functionality information includes or indicates a functionality corresponding to each AI model on the UE side. Upon establishing a connection with the network device, the UE may send the current supported AI functionality to the NW based on the function corresponding to the pre-configured AI model. This enables the NW to know the current AI functionality of the UE and feedback an LCM indication corresponding to the AI functionality to the UE based on the AI functionality and the current scenario requirement.

In step S202, second information sent by the network device is received.

For example, corresponding to the above AI functionality information, the LCM indication information sent by the network device based on the AI functionality information is functionality-based LCM indication information as described in the above implementation, in a case where the AI information received by the network device is the AI functionality information. The NW side sends the functionality-based LCM indication information to the UE, and the UE performs the life cycle management on the AI function in the UE according to the functionality-based LCM indication information.

In step S203, a plurality of AI model information matching the AI functionality information is determined, where the plurality of AI model information includes encoder model information and decoder model information, and any pair of encoder model and decoder model indicated by the plurality of AI model information meets a preset performance requirement.

It is worth mentioning that the UE in the embodiment is pre-configured with the plurality of AI model information under different AI functionalities. Each AI model information may be information configured to uniquely identify the AI model, such as, an AI model number, an AI model identity, or an AI model name. The plurality of AI model information under the same AI functionality may include one or more encoder model information and one or more decoder model information. The encoder model corresponding to any one of encoder model information may be paired with the decoder model corresponding to any one of decoder model information, and a performance parameter between any pair of encoder model and decoder model meets the preset performance requirement.

For example, it is assumed that the number of encoder model information in the plurality of AI model information under the same AI functionality is X, and the number of decoder model information is Y. Values of X and Y may be the same or different. The encoder model corresponding to any one of encoder model information selected from the X pieces of encoder model information may be paired with the decoder model corresponding to any one of decoder model information selected from the Y pieces of decoder model information, and the performance parameter between the paired encoder model and decoder model meets the preset performance requirement. The performance requirement may be an accuracy requirement, a clarity requirement, or an error requirement of interaction information. The basic transmission requirements, such as authenticity, clarity, and accuracy of the interaction information between the UE and the NW, can be ensured in a case where the encoder model and the decoder model meet the preset performance requirement.

For example, taking AI-based CSI compression and sending as an example, based on a preset AI functionality mapping table, the UE can look up the plurality of AI model information under the AI functionality from the AI functionality mapping table based on the preset AI functionality mapping table after sending the AI functionality information that supports the CSI compression. The plurality of AI model information includes one or more encoder models for CSI compression and sending, and one or more decoder models for CSI compression and sending. Any encoder model may be paired with any decoder model. Any encoder model selected by the UE from the encoder models may be paired with the AI functionality-based decoder model on the NW side. After the UE sends the supported AI functionality information, the UE side may select any encoder model under the AI functionality information from the preset AI functionality mapping table, and the NW side may select any decoder model under the AI functionality information from the preset AI functionality mapping table. Based on the arbitrary adaptability among the plurality of AI models under the same AI functionality, there is no need to notify the other sides, when selecting the model based on the above method. For example, after the UE sends the AI functionality information, the encoder model under the AI functionality may be selected as a management object for the life cycle management according to the current application scenario of the UE. The life cycle management on the encoder model is performed based on the LCM indication information fed back by the NW side.

In one implementation, the preset performance requirement includes at least one of the following: a square of a generalized cosine similarity between the encoder model and the decoder model is greater than a set similarity threshold; a normalized mean square error between the encoder model and the decoder model is less than a set error threshold; or a user-perceived throughput between the encoder model and the decoder model is greater than a set rate threshold.

It is worth mentioning that to achieve arbitrary adaptability between the encoder model and the decoder model and to ensure that paired encoder model and the decoder model can meet the above preset performance requirement, a correspondence test needs to be performed on the plurality of encoder models and the plurality of decoder models under the same AI functionality. In the embodiment, first, an arbitrary adaptability test is performed on the plurality of encoder models and the plurality of decoder models. Reference encoder models and reference decoder models may be defined before testing. Encoder models and decoder models that meet the requirement are selected based on the reference encoder models and the reference decoder models. Then the encoder models and the decoder models are paired for a performance test to select the encoder model and the decoder model that meet the preset performance requirement in any pairwise pairing. A preset AI functionality mapping table is generated based on the model information of the encoder model and the decoder model.

The preset performance requirement includes at least one of the following: (1) The square of the generalized cosine similarity between the paired encoder model and decoder model needs to be greater than the set similarity threshold. For example, the set similarity threshold is 0.8. The encoder model and the decoder model can meet the preset performance requirement after being paired, in a case where the square of the generalized cosine similarity between the encoder model and the decoder model is greater than 0.8. (2) The normalized mean square error (NMSE) between the encoder model and the decoder model is less than the set error threshold. For example, the set error threshold is −10 dB. The encoder model and the decoder model can meet the preset performance requirement after being paired, in a case where the NMSE between the encoder model and the decoder model is less than −10 dB. (3) In a case where the user-perceived throughput between the encoder model and the decoder model is greater than the set rate threshold, it is determined that the encoder model and the decoder model can meet the preset performance requirement after being paired.

For example, different weight values may be set for the three parameters based on an application requirement, in a case where the preset performance requirement needs to be measured based on the three parameters of the generalized cosine similarity, the NMSE, and the user-perceived throughput between the encoder model and the decoder model. A weighted parameter threshold for the three parameters is determined based on the weight values and a reference value corresponding to the paired reference encoder model and decoder model. Whether the paired encoder model and decoder model meet the preset performance requirement is determined according to the weighted parameter threshold.

In step S204, an AI model is determined from the encoder model according to the encoder model information.

For example, in the embodiment, any one encoder model within the plurality of AI models can be paired with any one decoder model within the plurality of AI models. This indicates that there is arbitrary adaptability between the encoder model and the decoder model within the plurality of AI models. Hence, when a plurality of AI model numbers are determined via the above AI functionality information, any one encoder model may be selected from the encoder model corresponding to the plurality of AI model numbers as the AI model for the life cycle management. It is worth mentioning that the above preset AI functionality mapping table includes a correspondence relationship between the plurality of AI functionality information and the plurality of AI model information. For an architecture between the functionality and model, refer to the AI architecture shown in FIG. 1, which will not be elaborated further in the embodiment. The contents of functionality and model information recorded in the preset AI functionality mapping table are classified into two cases: (1) the AI functionality information recorded in the preset AI functionality mapping table that is stored in the UE is the current AI functionality information that the UE can achieve. Hence, the AI model information corresponding to each AI functionality information is the AI model currently configured in the UE, and the UE arbitrarily selects an encoder model under the AI functionality information based on the sent AI functionality information; and (2) the preset AI functionality mapping table stored in the UE records all AI functionality information corresponding to the UE, and the corresponding AI model information refers to all AI models under the AI functionality. That is, the AI functionality mapping table is a reference table. The UE needs to determine an adaptable AI model from the table based on the AI functionality information that the UE supports and sends, and the currently configured AI model.

In step S205, the life cycle of the AI model corresponding to the AI information is determined according to the LCM indication information.

For example, the LCM indication information sent by the NW side based on the AI functionality information is the functionality-based LCM indication information, in a case where the AI information that the UE supports and sends is the AI functionality information. The UE directly performs the life cycle management on the AI model, based on the functionality-based LCM indication information. The method for managing the life cycle is the same as in the above step S103, which can be referred to the above step S103 without further elaboration.

By using the above method, the UE, after sending the supported AI functionality information to the NW, can perform the life cycle management on the model under the AI functionality information based on the LCM indication information sent by the NW, without the need to notify the AI model to the NW. This reduces the process of mutual notification and improves the communication efficiency while ensuring the communication performance.

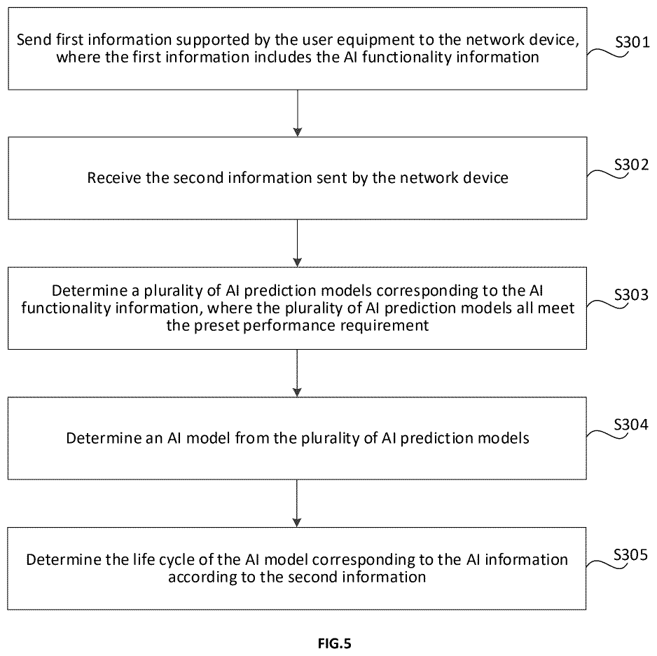

FIG. 5 is a flowchart of a method for life cycle management according to an example. As shown in FIG. 5, the method is performed by the UE and includes the following steps: S301-S305.

In step S301, first information supported by the user equipment is sent to the network device, where the first information includes the AI functionality information.

For example, in the embodiment, the sending and role of the AI functionality information are the same as in the above step S201, which can be referred to step S201 without further elaboration.

In step S302, the second information sent by the network device is received.

For example, in the embodiment, the method for receiving the second information is the same as in the above step S202, which can be referred to step S202 without further elaboration.

In step S303, a plurality of AI prediction models corresponding to the AI functionality information are determined, where the plurality of AI prediction models all meet the preset performance requirement.

For example, AI models corresponding to the AI functionality information are the AI prediction models in the embodiment. The AI prediction models are single-sided models, meaning that they are configured on the UE side. The AI prediction models predict communication information within a preset time range and then directly upload the communication information to the NW. For example, the AI functionality information is the CSI prediction function information. After sending the supported CSI prediction function to the NW, the UE determines a plurality of CSI prediction models corresponding to the CSI prediction function.

In the embodiment, the plurality of AI prediction models under the AI functionality information configured in the UE all meet the preset performance requirement. The preset performance requirement may be an accuracy requirement defined by a radio access network (RAN) 4, or may also be the preset performance requirement in the above step S203, which can be referred to the above step S203 without further elaboration.

In step S304, an AI model is determined from the plurality of AI prediction models.

For example, in the embodiment, any prediction model may be selected as the AI model from the plurality of AI prediction models, after the plurality of AI prediction models are determined based on the AI functionality information. A prediction model that meets the requirement may also be selected as the AI model from the plurality of AI prediction models based on the current communication state of the UE. After the AI model is selected and determined, the corresponding life cycle management is performed based on the AI model belonging to the AI functionality information, without the need to notify the NW side, where the AI model for LCM may include one or more models.

In step S305, the life cycle of the AI model corresponding to the AI information is determined according to the second information.

For example, in the embodiment, the method for life cycle management on the AI model is the same as in the above steps S205 and S103, which can be referred to the above steps S205 and S103 without further elaboration.

By using the above method, the UE may select the AI model from the plurality of AI prediction models corresponding to the AI functionality information and perform life cycle management based on the AI model under the AI functionality information, in a case where the AI model corresponding to the AI functionality information sent by the UE is an AI prediction model configured on one side. This ensures the communication performance without reporting the AI model to the NW; hence, the cost of information exchange between the UE and the NW is saved.

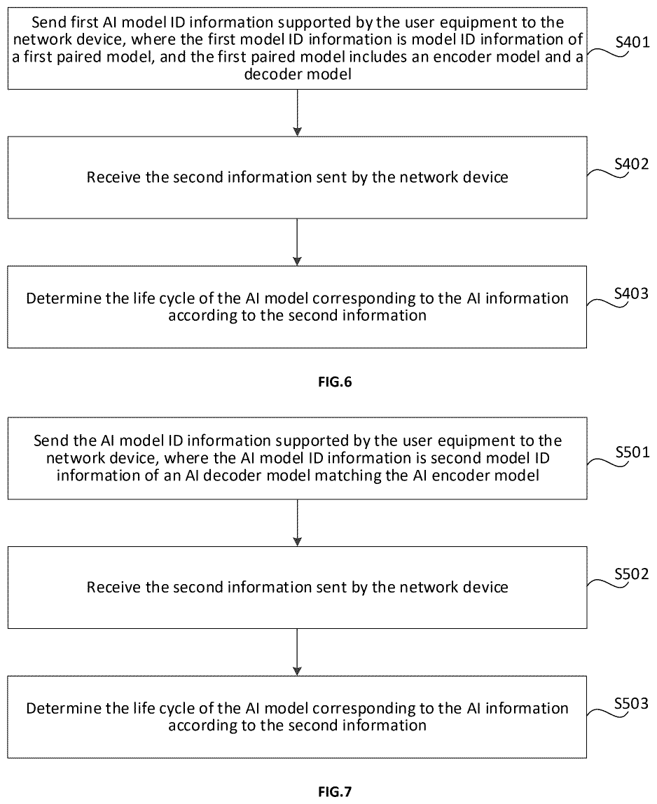

FIG. 6 is a flowchart of a method for life cycle management according to an example. As shown in FIG. 6, the method is performed by the UE, and the AI information includes AI model ID information. The method includes the following steps: S401-S403.

In step S401, first AI model ID information supported by the user equipment is sent to the network device, where the first model ID information is model ID information of a first paired model, and the first paired model includes an encoder model and a decoder model.

For example, in the embodiment, the first AI model ID information supported by the UE is sent to the NW, after an initial communication connection between the UE and the NW is established, where the first AI model ID information is the model ID information of the first paired model, and the first paired model includes the encoder model and the decoder model.

In the embodiment, the AI model of the UE based on AI is a dual-sided model, meaning that the encoder model is configured on the UE side, and the decoder model is configured on the NW side, where the encoder model and the decoder model are paired with each other. The paired encoder model and decoder model share one first AI model ID. By sending the supported first AI model ID information, the UE enables the NW, when applying the corresponding AI function, to use the decoder model under the same first AI model ID information to decode the AI communication information transmitted by the UE.

In one implementation, the encoder model and the decoder model included in the first paired model meet the preset performance requirement, and there is a one-to-one correspondence between the encoder model and the decoder model.

For example, in the embodiment, the encoder model and the decoder model, which correspond to the first AI model ID information, are in one-to-one correspondence. That is, the test cases for the encoder model and the decoder model include performance tests for X encoder models with X decoder models, totalling X combinations. Further, when the encoder models and decoder models among the X combinations are paired, they need to meet the preset performance requirement. The preset performance requirement in the embodiment is the same as in the above step S203, which can be referred to the above step S203 without further elaboration.

In step S402, the second information sent by the network device is received.

For example, in the embodiment, the AI information received by the network device is the AI model ID information. Therefore, LCM indication information generated by the network device based on the sent AI model ID information is the model-based LCM indication information. The UE performs the life cycle management on an AI model corresponding to the model-based LCM indication information.

In step S403, the life cycle of the AI model corresponding to the AI information is determined according to the second information.

For example, in the embodiment, the second information is a life cycle management indication for the encoder model under the first AI model ID information sent by the NW based on the first AI model ID information. Hence, the UE may perform the life cycle management on the corresponding AI model based on the model-based LCM indication information.

In one implementation, the second information includes first model indication information based on the first model ID information. The above step S403 includes the following steps: determining an AI model matching the first model ID information according to the first model indication information; and managing the life cycle of the AI model based on the first model indication information.

It is worth mentioning that in the embodiment, the encoder model on the UE side and the decoder model on the NW side share one piece of first model ID information. After the UE sends the supported first model ID information, the NW side performs the life cycle management on the encoder model under the first model ID information based on the first model ID information and the current application scenario to generate the first model indication information and feedback it to the UE, where the first model indication information is the model-based LCM indication information. The UE determines the AI encoder model configured on the UE side based on the model-based LCM indication information and then manages the life cycle of the AI encoder model based on the model-based LCM indication information.

By using the above method, the encoder model and the decoder model under the same AI model ID information are configured on the UE side and the NW side, respectively. By sending the supported AI model ID information, the UE enables the NW to perform the life cycle management on the corresponding encoder model based on the supported AI model ID information. In this way, the paired models in the AI communication interaction process can be clearly identified, and the communication performance of the AI model during the communication process can be ensured.

FIG. 7 is a flowchart of a method for life cycle management according to an example. As shown in FIG. 7, the method is performed by the UE, the AI information includes AI model ID information, and the AI model is the AI encoder model. The method includes the following steps: S501-S503.

In step S501, the AI model ID information supported by the user equipment is sent to the network device, where the AI model ID information is second model ID information of an AI decoder model matching the AI encoder model.

For example, the AI-based model in the embodiment includes the encoder model and the decoder model, meaning that the AI encoder model is configured on the UE side and the AI decoder model is configured on the NW side. The UE is pre-configured with an AI model ID information mapping table under a plurality of the AI functions, the AI model ID information mapping table includes encoder model ID information corresponding to X encoder models and decoder model ID information corresponding to Y decoder models, where X and Y may be the same or different. For example, when a communication connection between the UE and the NW is initially established, the UE sends the supported AI model ID information to the NW, where the AI model ID information is first determined by the UE based on its own configuration, as the ID information of the encoder model supported by the UE. Then, the second model ID information of the AI decoder model corresponding to the supported encoder model is determined according to the AI model ID information mapping table, and the second model ID information is uploaded to the NW.

In one implementation, the AI encoder model and the AI decoder model meet the preset performance requirement.

For example, in the embodiment, the corresponding AI encoder model and AI decoder model in the AI model ID information mapping table need to meet the preset performance requirement. The preset performance requirement is the same as in the above step S401, which can be referred to the above step S401 without further elaboration.

In step S502, the second information sent by the network device is received.

For example, the method for receiving the second information in the embodiment is the same as in the above step S402, which can be referred to the above step S402 without further elaboration.

In step S503, the life cycle of the AI model corresponding to the AI information is determined according to the second information.

For example, in the embodiment, the LCM indication information sent by the NW is model-based LCM indication information, where the model is the AI decoder model. Hence, the UE may determine the corresponding AI encoder model from the AI model ID information mapping table based on the AI encoder model and manage the life cycle of the AI encoder model based on the model-based LCM indication information.

In one implementation, the second information includes second model indication information based on the second model ID information. The above step S503 includes the following steps: determining the AI encoder model corresponding to the second model ID information according to the second model indication information; and managing the life cycle of the AI encoder model based on the second model indication information.

In a case where it is determined based on the AI model ID information mapping table that one AI decoder model under the same AI functionality corresponds to the plurality of AI encoder models, or that a plurality of AI decoder models correspond to a plurality of AI encoder models, the UE may select one or more from the plurality of AI encoder models as a target AI encoder model based on the plurality of AI encoder models and the current application scenario. Furthermore, the UE performs the life cycle management on the target AI encoder model according to the model-based LCM indication information.

By using the above method, after the UE sends the supported decoder model ID information, the NW feeds back a decoder model-based LCM indication, based on the ID information and the current application scenario. The UE randomly selects the target encoder model from the corresponding encoder models based on the decoder model and performs the life cycle management on the target decoder model based on the LCM indication. Hence, the NW does not need to know the encoder model selected by the UE during the model selection process. The UE autonomously selects the encoder model from the encoder models that meet the condition. This enables the UE to autonomously select the corresponding AI model while ensuring the AI model performance during the communication process, which improves the flexibility of model selection.

FIG. 8 is a flowchart of a method for life cycle management according to an example. As shown in FIG. 8, the method is performed by the network device and includes the following steps: S601-S603.

In step S601, the first information sent by the user equipment is received, where the first information indicates the AI information supported by the user equipment.

For example, in the embodiment, the method for receiving, by the network device, the first information sent by the UE is the same as in the above step S101, which can be referred to the above step S101 without further elaboration.

In step S602, the second information is generated according to the first information, where the second information indicates the LCM indication information.

For example, in the embodiment, after the network device receives the first information, the second information based on the first information is generated according to the first information and the current application scenario of the network device, where the second information is configured to indicate the LCM indication information. The method for generating the second information can be referred to the above step S102 without further elaboration.

In one implementation, the second information includes at least one of: the activation indication, the deactivation indication, the fallback indication, the switching indication, the selection indication, or the update indication for the AI encoder model.

For example, in the embodiment, the definition of the second information is the same as in the above step S101, which can be referred to the above step S101 without further elaboration.

In step S603, the second information is sent to the user equipment, where the second information is configured to indicate that the user equipment determines the life cycle of the AI model corresponding to the AI information according to the second information.

For example, in the embodiment, the method for sending the second information is the same as in the above step S102, which can be referred to the above step S102 without further elaboration. The role of the second information is the same as in the above step S103 and will not be elaborated further.

In another implementation, the above step S603 includes the following step: sending the second information to the user equipment via indication signaling, where the indication signaling includes at least one of: the RRC signaling, the MAC CE signaling, or the DCI signaling.

For example, in the embodiment, the network device may send the LCM indication information to the UE via the indication signaling, where the indication signaling includes at least one of: the radio resource control (RRC) signaling, the medium access control element (MAC CE) signaling, or the downlink control information (DCI) signaling.

By using the above method, the NW receives the AI information sent by the UE, enabling the NW to manage the life cycle of the AI model based on the AI information supported by the UE. This avoids the disruption of the AI function caused by mismatched AI models and ensures the performance of the AI model during the communication process.

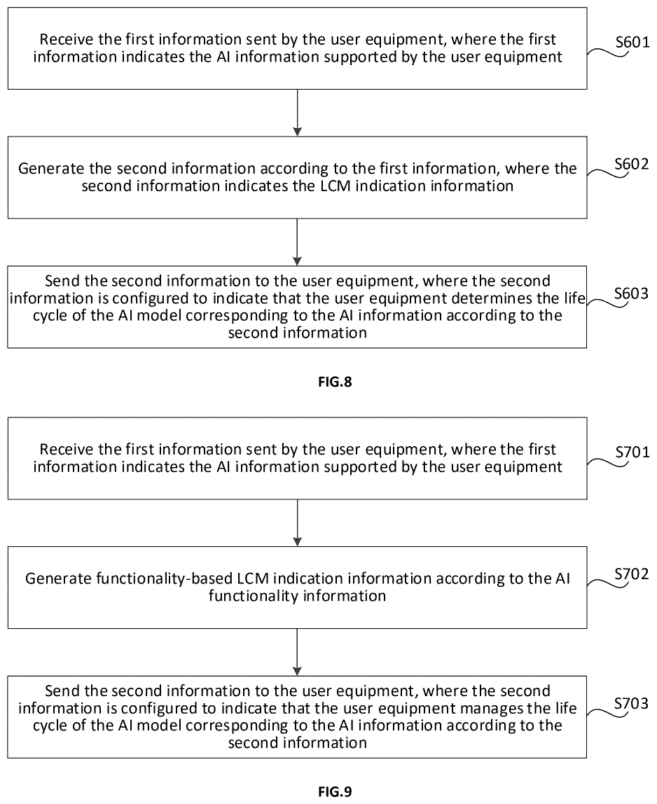

FIG. 9 is a flowchart of a method for life cycle management according to an example. As shown in FIG. 9, the method is performed by the network device, and the AI information includes the AI functionality information. The method includes the following steps: S701-S703.

In step S701, the first information sent by the user equipment is received, where the first information indicates the AI information supported by the user equipment.

For example, in the embodiment, the first information sent by the UE is the AI functionality information, and the method for receiving the AI functionality information by the network device is the same as in the above step S201, which can be referred to the above step S201 without further elaboration.

In step S702, the functionality-based LCM indication information is generated according to the AI functionality information.

For example, in the embodiment, the network device generates the functionality-based LCM indication information based on the AI functionality information, in a case where the first information sent by the UE is the AI functionality information. The functionality-based LCM indication information is functionality-based LCM indication information. The method for generating the functionality-based LCM indication information is the same as in the above step S102, which can be referred to the above step S102 without further elaboration.

In step S703, the second information is sent to the user equipment, where the second information is configured to indicate that the user equipment manages the life cycle of the AI model corresponding to the AI information according to the second information.

For example, in the embodiment, the method for sending the second information is the same as in the above step S102, which can be referred to the above step S102 without further elaboration. The role of the second information is the same as in the above step S103 and will not be elaborated further.

In one implementation, the AI model is the AI encoder model. Before the above step S703, the method further includes the following steps: determining, from the network device, the plurality of AI model information matching the AI functionality information, where the plurality of AI model information includes encoder model information and decoder model information, and any pair of encoder model and decoder model indicated by the plurality of AI model information meets the preset performance requirement; and determining the AI decoder model corresponding to the AI encoder model from the encoder model according to the decoder model information.

For example, in the embodiment, the method for determining the plurality of AI model information in the network device and the definition of the AI model information are the same as in the above step S203, which can be referred to the above step S203 without further elaboration.

The method for determining the AI encoder model according to the decoder model is the same as the method for determining the AI encoder model according to the encoder model in the above step S204, which can be referred to the above step S204 without further elaboration.

For example, in the embodiment, the definition of the preset performance requirement is the same as in the above step S203, which can be referred to the above step S203 without further elaboration.

By using the above method, after sending the supported AI functionality information to the NW, the UE can perform the life cycle management on the model under the AI functionality information based on the second information sent by the NW, without the need to notify the AI model to the NW. This reduces the process of mutual notification and improves the communication efficiency while ensuring the communication performance.

In another implementation, the AI model is the AI prediction model. The above step S703 includes the following step of sending the functionality-based LCM indication information, where the functionality-based LCM indication information is configured to indicate that the user equipment manages the life cycle of the AI prediction model corresponding to the AI information according to the functionality-based LCM indication information.

For example, in the embodiment, the AI model supported by the UE is the AI prediction model, where the AI prediction model is the single-sided model. The method for managing the life cycle of the AI prediction model by the network device via sending the functionality-based LCM indication information is the same as in the above step S303, which can be referred to the above step S303 without further elaboration.

By using the above method, the UE may select any model from the plurality of AI prediction models corresponding to the AI functionality information to perform the life cycle management on the AI model, in a case where the AI model corresponding to the AI functionality information sent by the UE is the AI prediction model configured on the single side. This ensures the communication performance without reporting the AI model to the NW, and hence, the cost of information exchange between the NW and the UE is saved.

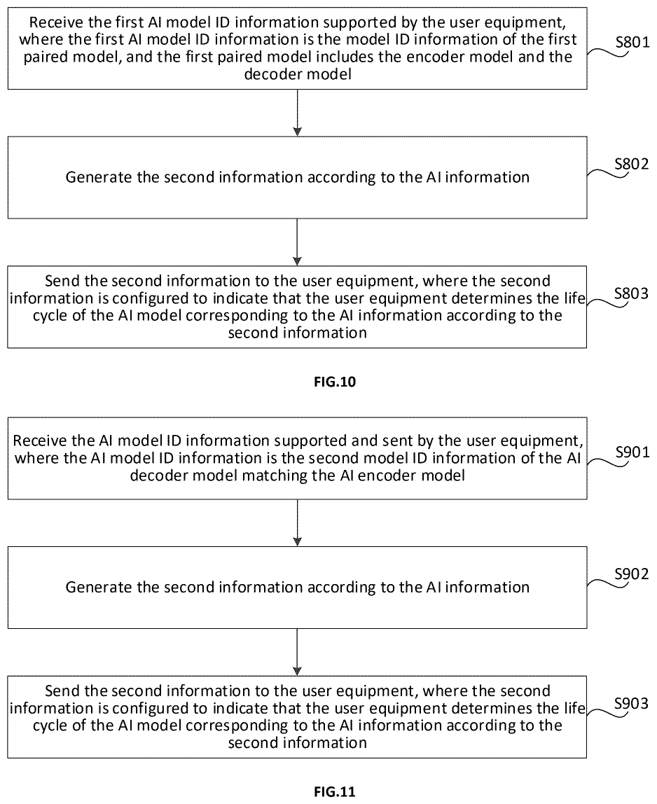

FIG. 10 is a flowchart of a method for life cycle management according to an example. As shown in FIG. 10, the method is performed by the network device, the AI information includes the AI model ID information, and the AI model is the AI encoder model. The method includes the following steps: S801-S803.

In step S801, the first AI model ID information supported by the user equipment is received, where the first AI model ID information is the model ID information of the first paired model, and the first paired model includes the encoder model and the decoder model.

For example, in the embodiment, the method for receiving the first AI model ID information and the definition of the first AI model ID information are the same as in the above step S401, which can be referred to the above step S401 without further elaboration.

In one implementation, the encoder model and the decoder model included in the first paired model meet the preset performance requirement and there is the one-to-one correspondence between the encoder model and the decoder model.

For example, in the embodiment, the first paired model is the same as in the above step S401, which can be referred to the above step S401 without further elaboration.

In step S802, the second information is generated according to the AI information.

For example, in the embodiment, the method for generating the second information is the same as in the above step S402, which can be referred to the above step S402 without further elaboration.

In another implementation, the above step S802 includes the following step of generating the first model indication information according to the first model ID information, where the first model indication information is configured to manage the life cycle of the AI model, and the first model ID information matches the AI encoder model.

For example, in the embodiment, the method for generating the first model indication information and the role of the first model indication information are the same as in the above step S403, which can be referred to the above step S403 without further elaboration.

In step S803, the second information is sent to the user equipment, where the second information is configured to indicate that the user equipment determines the life cycle of the AI model corresponding to the AI information according to the second information.

For example, in the embodiment, the method for sending the second information by the network device is the same as in the above step S403, which can be referred to the above step S403 without further elaboration.

By using the above method, the encoder model and the decoder model under the same AI model ID information are configured on the UE side and the NW side, respectively. By sending the supported AI model ID information, the UE enables the NW to perform the life cycle management on the encoder model corresponding to the information. In this way, the paired models in the AI communication interaction process can be clearly identified, and the communication performance of the AI model during the communication process can be ensured.

FIG. 11 is a flowchart of a method for life cycle management according to an example. As shown in FIG. 11, the method is performed by the network device, the AI information includes the AI model ID information, and the AI model is the AI encoder model. The method includes the following steps: S901-S903.

In step S901, the AI model ID information supported and sent by the user equipment is received, where the AI model ID information is the second model ID information of the AI decoder model matching the AI encoder model.

For example, in the embodiment, the method for receiving the AI model ID information and the definition of the second model ID information are the same as in the above step S501, which can be referred to the above step S501 without further elaboration.

In one implementation, the AI encoder model and the AI decoder model meet the preset performance requirement.

For example, in the embodiment, the definition of the preset performance requirement is the same as in the above step S501, which can be referred to the above step S501 without further elaboration.

In step S902, the second information is generated according to the AI information.

For example, in the embodiment, the method for generating the second information is the same as in the above step S502, which can be referred to the above step S502 without further elaboration.

In another implementation, the above step S902 includes the following step of generating the second model indication information according to the second model ID information, where the second model indication information is configured to manage the life cycle of the AI encoder model, where the second model ID information corresponds to the AI encoder model.

For example, in the embodiment, the method for generating the second model indication information is the same as in the above step S503, which can be referred to the above step S503 without further elaboration.

In step S903, the second information is sent to the user equipment, where the second information is configured to indicate that the user equipment determines the life cycle of the AI model corresponding to the AI information according to the second information.

For example, in the embodiment, the method for sending the second information is the same as in the above step S503, which can be referred to the above step S503 without further elaboration.

By using the above method, after the UE sends the supported decoder model ID information, the NW feeds back decoder model-based LCM indication based on the ID information and the current application scenario. The UE randomly selects the target encoder model from corresponding encoder model based on the decoder model and performs life cycle management on the target decoder model based on the LCM indication. Hence, the NW does not need to know the encoder model selected by the UE during the model selection process. The UE autonomously selects an encoder model from the encoder model that meets the condition. This enables the UE to autonomously select the corresponding AI model while ensuring the AI model performance during the communication process, which improves the flexibility of model selection.

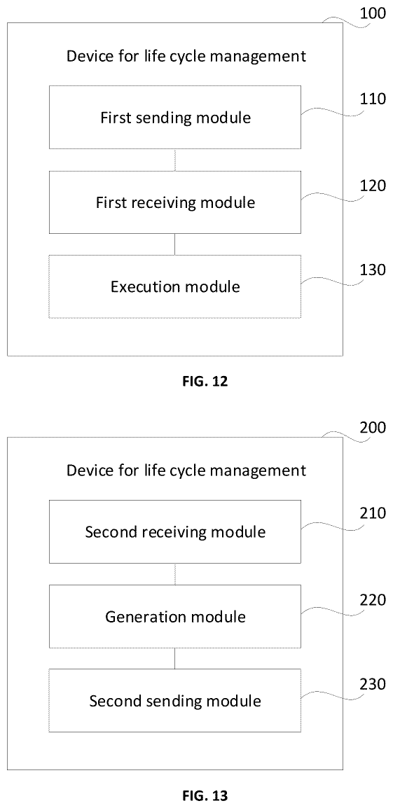

FIG. 12 is a block diagram of a device for life cycle management according to an example. As shown in FIG. 12, the device 100 is applied to the user equipment and includes: a first sending module 110, a first receiving module 120 and an execution module 130.

The first sending module 110 is configured to send the first information to the network device, where the first information indicates the AI information supported by the user equipment.

The first receiving module 120 is configured to receive the second information sent by the network device, where the second information indicates the LCM indication information.

The execution module 130 is configured to determine the life cycle of the AI model corresponding to the AI information according to the second information.

In one implementation, the first information includes the AI functionality information, and the AI model is the encoder model corresponding to the encoder model information in the plurality of AI model information, where the plurality of AI model information includes the encoder model information and the decoder model information, and any pair of encoder model and decoder model indicated by the plurality of AI model information meets the preset performance requirement.

In one implementation, the first information includes the AI functionality information, and the AI model is the AI prediction model corresponding to the AI functionality information. The AI prediction model meets the preset performance requirement.

In one implementation, the AI information includes the AI model ID information. The first sending module 110 is configured to send the first AI model ID information supported by the user equipment to the network device, where the first AI model ID information is the model ID information of the first paired model, and the first paired model includes the encoder model and the decoder model.

In one implementation, the encoder model and the decoder model included in the first paired model meet the preset performance requirement, and there is a one-to-one correspondence between the encoder model and the decoder model.

In one implementation, the execution module 130 is configured to: determine the AI model matching the first model ID information according to the first model indication information; and determine the life cycle of the AI model based on the first model indication information.

In one implementation, the AI information includes the AI model ID information, and the AI model is the AI encoder model. The first sending module 110 is configured to send the AI model ID information supported by the user equipment to the network device, where the AI model ID information is the second model ID information of the AI decoder model matching the AI encoder model.

In one implementation, the AI encoder model and the AI decoder model meet the preset performance requirement.

In one implementation, the LCM indication information includes the second model indication information based on the second model ID information. The execution module 130 is configured to: determine the AI encoder model corresponding to the second model ID information according to the second model indication information; and manage the life cycle of the AI encoder model based on the second model indication information.

In one implementation, the preset performance requirement includes at least one of the following: the square of the generalized cosine similarity between the encoder model and the decoder model is greater than the set similarity threshold; the normalized mean square error between the encoder model and the decoder model is less than the set error threshold; or the user-perceived throughput between the encoder model and the decoder model is greater than the set rate threshold.

In one implementation, the LCM indication information includes at least one of: the activation indication, the deactivation indication, the fallback indication, the switching indication, the selection indication, or the update indication for the AI encoder model.

Regarding the devices in the above embodiments, the specific way in which each module performs operations has been described in detail in the relevant method embodiments and will not be further detailed here.

FIG. 13 is a block diagram of a device 200 for life cycle management according to an example. As shown in FIG. 13, the device is applied to the network device and includes: a second receiving module 210, a generation module 220 and a second sending module 230.

The second receiving module 210 is configured to receive the first information sent by the user equipment, where the first information indicates the AI information supported by the user equipment.

The generation module 220 is configured to generate the second information according to the first information, where the second information indicates the LCM indication information.

The second sending module 230 is configured to send the second information to the user equipment, where the second information is configured to indicate that the user equipment determines the life cycle of the AI model corresponding to the AI information according to the second information.

In one implementation, the AI information includes the AI functionality information. The generation module 220 is configured to generate the second information according to the AI functionality information, where the second information indicates functionality-based LCM indication information.

In one implementation, the AI model is the AI encoder model. The device 200 further includes a third determination module, where the third determination module is configured to determine, from the network device, the plurality of AI model information matching the AI functionality information, where the plurality of AI model information includes the encoder model information and the decoder model information, and any pair of encoder model and decoder model indicated by the plurality of AI model information meets the preset performance requirement; and determine the AI decoder model corresponding to the AI encoder model from the encoder models according to the decoder model information.

In one implementation, the AI model is the AI prediction model. The second sending module 230 is configured to send the functionality-based LCM indication information, where functionality-based LCM indication information is configured to indicate that the user equipment determines the life cycle of the AI prediction model corresponding to the AI information according to the functionality-based LCM indication information.

In one implementation, the AI information includes the AI model ID information, and the AI model is the AI encoder model. The second receiving module 210 is configured to receive the first AI model ID information supported by the user equipment, where the first AI model ID is the model ID information of the first paired model, and the first paired model includes the encoder model and the decoder model.

In one implementation, the encoder model and the decoder model included in the first paired model meet the preset performance requirement, and there is a one-to-one correspondence between the encoder model and the decoder model.

In one implementation, the generation module 220 is configured to generate the first model indication information according to the first model ID information, where the first model indication information is configured to determine the life cycle of the AI model, and the first model ID information matches the AI encoder model.

In one implementation, the AI information includes the AI model ID information, and the AI model is the AI encoder model. The second receiving module 210 is configured to receive the AI model ID information supported and sent by the user equipment, where the AI model ID information is the second model ID information of the AI decoder model matching the AI encoder model.

In one implementation, the AI encoder model and the AI decoder model meet the preset performance requirement.

In one implementation, the generation module 220 is configured to generate the second model indication information according to the second model ID information, where the second model indication information is configured to manage the life cycle of the AI encoder model, and the second model ID information corresponds to the AI encoder model.

In one implementation, the preset performance requirement includes at least one of the following: the square of the generalized cosine similarity between the encoder model and the decoder model is greater than the set similarity threshold; the normalized mean square error between the encoder model and the decoder model is less than the set error threshold; or the user-perceived throughput between the encoder model and the decoder model is greater than the set rate threshold.

In one implementation, the second sending module 230 is configured to send the LCM indication information to the user equipment via the indication signaling, where the indication signaling includes at least one of: the RRC signaling, the MAC CE signaling, or the DCI signaling.

In one implementation, the LCM indication information includes at least one of: the activation indication, the deactivation indication, the fallback indication, the switching indication, the selection indication, or the update indication for the AI encoder model.

Regarding the devices in the above embodiments, the specific way in which each module performs operations has been described in detail in the relevant method embodiments and will not be further detailed here.

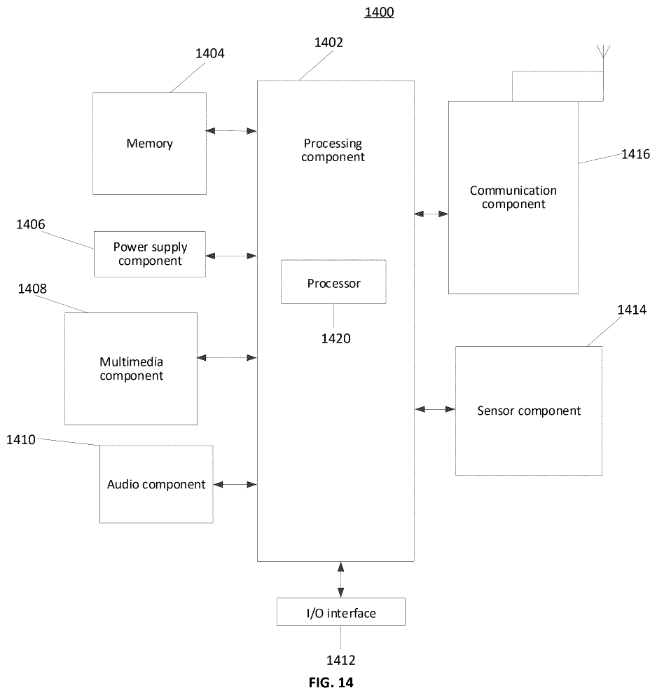

FIG. 14 is a block diagram of a user equipment according to an example. For example, the user equipment 1400 may be the above test device or synchronization device. The user equipment 1400 may be a mobile phone, a computer, a digital broadcasting device, a message sending and receiving device, a game console, a tablet device, a medical device, a fitness device, a personal digital assistant, etc.

Referring to FIG. 14, the user equipment 1400 may include one or more of the following components: a processing component 1402, a memory 1404, a power supply component 1406, a multimedia component 1408, an audio component 1410, an input/output (I/O) interface 1412, a sensor component 1414, and a communication component 1416.

The processing component 1402 generally controls the overall operation of the user equipment 1400, such as operations associated with display, phone calls, data communication, camera operations, and recording operations. The processing component 1402 may include one or more processors 1420 to execute instructions to complete all or part of the steps of the method for life cycle management. Furthermore, the processing component 1402 may include one or more modules to facilitate interaction between the processing component 1402 and other components. For example, the processing component 1402 may include a multimedia module to facilitate interaction between the multimedia component 1408 and the processing component 1402.

The memory 1404 is configured to store various types of data to support the operation of the user equipment 1400. Examples of this data include instructions for any applications or methods operating on the user equipment 1400, contact data, phone book data, messages, pictures, videos, etc. The memory 1404 may be implemented by any volatile or any non-volatile memory device or a combination of them, such as a static random access memory (SRAM), an electrically erasable programmable read-only memory (EEPROM), an erasable programmable read-only memory (EPROM), a programmable read-only memory (PROM), a read-only memory (ROM), a magnetic storage, a flash memory, a magnetic disk or an optical disk.

The power supply component 1406 supplies power to various components of the user equipment 1400. The power supply component 1406 may include a power supply management system, one or more power sources, and other components associated with generating, managing and distributing power for the user equipment 1400.

The multimedia component 1408 includes a screen that provides one output interface between the user equipment 1400 and a user. In some embodiments, the screen may include a liquid crystal display (LCD) and a touch panel (TP). In a case where the screen includes a touch panel, the screen may be implemented as a touch screen to receive an input signal from the user. The touch panel includes one or more touch sensors to sense touches, slides, and gestures on the touch panel. The touch sensor can not only sense a boundary of a touch or slide action, but also detect the duration and pressure associated with the touch or slide operation. In some embodiments, the multimedia component 1408 includes at least one of: a front camera or a rear camera. At least one of the front camera or rear camera can receive external multimedia data, in a case where the user equipment 1400 is in an operating mode, such as a shooting mode or a video mode. Each of the front camera and the rear camera may be a fixed optical lens system or may have focal length and optical zoom capability.

The audio component 1410 is configured to perform at least one of outputting or inputting an audio signal. For example, the audio component 1410 includes one microphone (MIC). The microphone is configured to receive an external audio signal in a case where the user equipment 1400 is in the operating mode, such as a calling mode, a recording mode, or a voice recognition mode. The received audio signal may be further stored in the memory 1404 or sent via the communication component 1416. In some embodiments, the audio component 1410 also includes one speaker for outputting the audio signal.

The I/O interface 1412 provides an interface between the processing component 1402 and a peripheral interface module. The peripheral interface module may be a keyboard, a click wheel, buttons, etc. These buttons may include, but are not limited to, a home button, a volume button, a start button and a lock button.

The sensor component 1414 includes one or more sensors to provide state assessments for the user equipment 1400 in various aspects. For example, the sensor component 1414 can detect an on/off state of the user equipment 1400, and the relative positioning of a component. For example, the component is the display and keypad of the device 1400. The sensor component 1414 can further detect a change in the position of the user equipment 1400 or one component of the user equipment 1400, the presence or absence of a contact between the user and the user equipment 1400, the orientation, acceleration, or deceleration of the user equipment 1400, and a temperature change of the user equipment 1400. The sensor component 1414 may include a proximity sensor configured to detect the presence of a nearby object without any physical contact. The sensor component 1414 may also include a light sensor, such as a complementary metal-oxide-semiconductor (CMOS) or charge-coupled device (CCD) image sensor, for use in imaging applications. In some embodiments, the sensor component 1414 may also include an acceleration sensor, a gyroscope sensor, a magnetic sensor, a pressure sensor, or a temperature sensor.

The communication component 1416 is configured to facilitate communication between the user equipment 1400 and other devices in a wired or wireless manner. The user equipment 1400 can access a wireless network based on a communication standard, such as WiFi, 5G, 6G or a combination of them. In one example, the communication component 1416 receives a broadcast signal or broadcast-related information from an external broadcast management system via a broadcast channel. In one example, the communication component 1416 also includes a near field communication (NFC) module to facilitate short-range communication. For example, the NFC module may be implemented based on a radio-frequency identification (RFID) technology, an infrared data association (IrDA) technology, an ultra-wideband (UWB) technology, a Bluetooth (BT) technology, and other technologies.

In examples, the user equipment 1400 may be implemented by using one or more application-specific integrated circuits (ASICs), digital signal processors (DSPs), digital signal processing devices (DSPDs), programmable logic devices (PLDs), field-programmable gate array (FPGA)s (FPGAs), controllers, microcontrollers, microprocessors or other electronic elements to perform the method for life cycle management.

In examples, a non-transitory computer-readable storage medium including instructions is further provided, such as a memory 1404 including instructions. The above instructions can be executed by the processor 1420 of the user equipment 1400 to complete the method for life cycle management. For example, the non-transitory computer-readable storage medium may be a ROM, a random access memory (RAM), a compact disc read-only memory (CD-ROM), a magnetic tape, a floppy disk, an optical data storage device, etc.

As used herein, the term processor may refer to one processor that performs the defined functions or a plurality of processors that collectively perform defined functions, such that the execution of the individual defined functions may be divided amongst such processors.

The above device may be an independent electronic device or a part of an independent electronic device. For example, in one implementation, the device may be an integrated circuit (IC) or a chip, where the integrated circuit may be a single IC or a set of a plurality of ICs. The chip may include, but is not limited to, the following types: a graphics processing unit (GPU), a central processing unit (CPU), a field programmable gate array (FPGA), a digital signal processor (DSP), an application specific integrated circuit (ASIC), a system on chip (SoC), etc. The above integrated circuit or chip may be configured to execute executable instructions (or codes) to implement the above method for life cycle management. The executable instructions may be stored in the integrated circuit or chip, or obtained from other devices or equipment. For example, the integrated circuit or chip includes a processor, a memory, and an interface for communication with other devices. The executable instructions may be stored in the processor, and when executed by the processor, implement the above method for life cycle management. Alternatively, the integrated circuit or chip may receive executable instructions via the interface and transmit them to the processor for execution to implement the above method for life cycle management.

In another example, a computer program product is further provided. The computer program product includes a computer program executable by a programmable device, where the computer program has a code part, when executed by the programmable device, implements the above method for life cycle management.

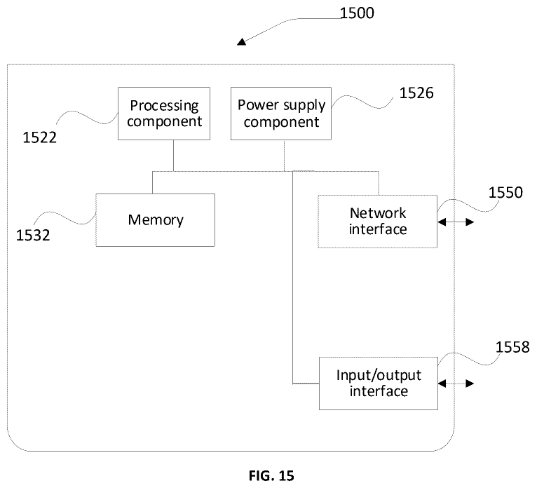

FIG. 15 is a block diagram of a network device 1500 according to an example. For example, the network device 1500 may be provided as a server that may serve as the above synchronization device or measurement device. Referring to FIG. 15, the network device 1500 includes a processing component 1522, which further includes one or more processors, and a memory source represented by a memory 1532 for storing instructions executable by the processing component 1522, such as an application. The application stored in the memory 1532 may include one or more modules, and each module corresponds to a set of instructions. Furthermore, the processing component 1522 is configured to execute the instructions to implement the above method for life cycle management.

The network device 1500 may also include one power supply component 1526 configured to perform power supply management for the network device 1500, a wired or wireless network interface 1550 configured to connect the network device 1500 to a network, and an input/output (I/O) interface 1558. The network device 1500 may operate based on an operating system stored in the memory 1532.

Those skilled in the art will readily think of other implementations of the present disclosure after considering the specification and practicing the present disclosure. The present disclosure is intended to cover any variations, uses or adaptations of the present disclosure. These variations, uses, or adaptations follow the general principles of the present disclosure and include common knowledge or conventional techniques in the technical field that are not disclosed in the present disclosure. The specification and the embodiments are considered as merely illustrative, and the true scope and spirit of the present disclosure are indicated by the following claims.

It is to be understood that the present disclosure is not limited to the precise structure already described above and shown in the accompanying drawings, and various modifications and changes can be made without departing from the scope of the present disclosure. The scope of the present disclosure is limited merely by the appended claims.

1. A method for life cycle management (LCM), performed by a user equipment, comprising:
sending first information to a network device, wherein the first information indicates artificial intelligence (AI) information supported by the user equipment;
receiving second information sent by the network device, wherein the second information indicates LCM indication information; and
determining a life cycle of an AI model corresponding to the AI information according to the second information.

2. The method according to claim 1, wherein the first information comprises AI functionality information, the AI model is an encoder model corresponding to encoder model information in a plurality of AI model information, the plurality of AI model information comprises the encoder model information and decoder model information, and any pair of encoder model and decoder model indicated by the plurality of AI model information meets a preset performance requirement.

3. The method according to claim 1, wherein the first information comprises AI functionality information, the AI model is an AI prediction model corresponding to the AI functionality information, and the AI prediction model meets a preset performance requirement.

4. The method according to claim 1, wherein the first information comprises AI model identifier (ID) information, and sending the first information to the network device comprises:
sending first AI model ID information supported by the user equipment to the network device, wherein the first AI model ID information is model ID information of a first paired model, and the first paired model comprises an encoder model and a decoder model.

5. The method according to claim 4, wherein the encoder model and the decoder model comprised in the first paired model meet a preset performance requirement, and there is a one-to-one correspondence between the encoder model and the decoder model.

6. The method according to claim 4, wherein the second information comprises first model indication information based on first model ID information, and determining the life cycle of the AI model according to the second information comprises:
determining the AI model matching the first model ID information according to the first model indication information; and
determining the life cycle of the AI model based on the first model indication information.

7. The method according to claim 1, wherein the first information comprises AI model ID information, the AI model is an AI encoder model, and sending the first information to the network device comprises:
sending the AI model ID information supported by the user equipment to the network device, wherein the AI model ID information is second model ID information of an AI decoder model matching the AI encoder model.

8. The method according to claim 7, wherein the AI encoder model and the AI decoder model meet a preset performance requirement.

9. The method according to claim 7, wherein the second information comprises second model indication information based on the second model ID information, and determining the life cycle of the AI model corresponding to the AI information according to the second information comprises:
determining the AI model corresponding to the second model ID information according to the second model indication information; and
determining the life cycle of the AI model based on the second model indication information.

10. The method according to claim 2, wherein the preset performance requirement comprises at least one of the following:
a square of a generalized cosine similarity between the encoder model and the decoder model is greater than a set similarity threshold;
a normalized mean square error between the encoder model and the decoder model is less than a set error threshold; or
a user-perceived throughput between the encoder model and the decoder model is greater than a set rate threshold.

11. The method according claim 1, wherein the LCM indication information comprises at least one of: an activation indication, a deactivation indication, a fallback indication, a switching indication, a selection indication, or an update indication for the AI encoder model.

12. A method for life cycle management (LCM), performed by a network device, comprising:
receiving first information sent by a user equipment, wherein the first information indicates artificial intelligence (AI) information supported by the user equipment;
generating second information according to the first information, wherein the second information indicates LCM indication information; and
sending the second information to the user equipment, wherein the second information is configured to indicate that the user equipment determines a life cycle of an AI model corresponding to the AI information according to the second information.

13. The method according to claim 12, wherein the first information comprises AI functionality information, and generating the second information according to the first information comprises:
generating the second information according to the AI functionality information, wherein the second information indicates functionality-based LCM indication information.

14. The method according to claim 13, wherein the AI model is an AI encoder model, and the method further comprises:
determining, from the network device, a plurality of AI model information matching the AI functionality information, wherein the plurality of AI model information comprises encoder model information and decoder model information, and any pair of encoder model and decoder model indicated by the plurality of AI model information meets a preset performance requirement; and
determining an AI decoder model corresponding to the AI encoder model from the encoder model, according to the decoder model information; or
wherein the AI model is an AI prediction model, and sending the second information to the user equipment comprises:
sending the functionality-based LCM indication information, wherein the functionality-based LCM indication information is configured to indicate that the user equipment determines the life cycle of the AI prediction model corresponding to the AI information according to the functionality-based LCM indication information.

15. (canceled)

16. The method according to claim 12, wherein the first information comprises first AI model identifier (ID) information, the AI model is an AI encoder model, and receiving the first information sent by the user equipment comprises:
receiving the first AI model ID information supported by the user equipment, wherein the first AI model ID information is model ID information of a first paired model, and the first paired model comprises an encoder model and a decoder model; or
wherein the first information comprises AI model ID information, the AI model is an AI encoder model, and receiving the first information sent by the user equipment comprises:
receiving the AI model ID information supported and sent by the user equipment, wherein the AI model ID information is second model ID information of an AI decoder model matching the AI encoder model.

17. (canceled)

18. The method according to claim 16, wherein generating the second information according to the first information comprises:
generating first model indication information according to the first model ID information, wherein the first model ID information is configured to determine the life cycle of the AI model, and the first model ID information matches the AI encoder model.

19-20. (canceled)

21. The method according to claim 16, wherein generating the second information according to the first information comprises:
generating second model indication information according to the second model ID information, wherein the second model indication information is configured to manage the life cycle of the AI encoder model, and the second model ID information corresponds to the AI encoder model.

22. (canceled)

23. The method according to claim 12, wherein sending the second information to the user equipment comprises:
sending the LCM indication information to the user equipment via indication signaling, where the indication signaling comprises at least one of: radio resource control (RRC) signaling, medium access control control element (MAC CE) signaling, or downlink control information (DCI) signaling.

24-26. (canceled)

27. A device for life cycle management (LCM), applied to a user equipment, comprising:
one or more processors; and
a memory that stores processor-executable instructions, wherein the processor-executable instructions, when collectively executed by the one or more processors, cause the one or more processors to:
send first information to a network device, wherein the first information indicates artificial intelligence (AI) information supported by the user equipment;
receive second information sent by the network device, wherein the second information indicates LCM indication information; and
determine a life cycle of an AI model corresponding to the AI information according to the second information.

28. (canceled)

29. A non-transitory computer-readable storage medium storing computer program instructions, wherein the computer program instructions, when executed by a processor, cause the processor to perform the method according to claim 1.

30. (canceled)
